(19) United States
(12) Patent Application Publication
(10) Pub. No.: US 2009/0027575 A1
(43) Pub. Date: Jan. 29, 2009

(54) Display apparatus

(75) Inventors: Jun Miyauchi, Kanagawa (JP); Koji Hirai, Tokyo (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/218,931

(22) Filed: Jul. 18, 2008

(30) Foreign Application Priority Data
Jul. 24, 2007 (JP) P2007-192173

(51) Int. Cl. G02F 1/13

(52) U.S. Cl. 349/5

(57) ABSTRACT

A display apparatus includes: a light source; spatial light modulation device for modulating light emitted by the light source based on a video signal; intensity distribution adjusting means for changing an angle-dependent intensity distribution of an incident light in response to luminance factor in the video signal, the intensity distribution adjusting means being arranged ahead of or behind the spatial light modulation device; and correction means for correcting the video signal in accordance with an intensity distribution adjusted by the intensity distribution adjusting means, and supplying a corrected video signal to the spatial light modulation device, in which the correction means has a plurality of correction tables each corresponding to a predetermined intensity distribution, generates a mixed correction value by mixing correction values in the plurality of correction tables at a mixing ratio determined by an individual intensity distribution, and corrects the video signal by using the mixed correction value.

### CROSS REFERENCES TO RELATED APPLICATIONS

The present invention contains subject matter related to Japanese Patent Application JP 2007-192173 filed in the Japanese Patent Office on Jul. 24, 2007, the entire contents of which being incorporated here by reference.

### BACKGROUND OF THE INVENTION

1. Field of the Invention

The present invention relates to a display apparatus applicable to a liquid crystal projector and the like.

2. Description of the Related Art

Projection display apparatuses such as liquid crystal projectors have been widely used which are configured to display an image by subjecting the light entered into a spatial light modulation device to spatial modulation, and emitting the modulated light, and then collecting and projecting the emitted light in accordance with an electric signal supplied to the spatial light modulation device. The projection display apparatus generally has a lamp and a condensing mirror as light sources, and an illumination optical system for collecting and admitting the light from these two light sources into the spatial light modulation device. The light from the spatial light modulation device is projected onto a screen or the like by a projection lens.

Examples of the abovementioned projection display apparatus include those having a variable iris capable of stopping down the incident light in order to improve the contrast ratio. Specifically, when the luminance level of a video signal is high (the image is bright), the iris is opened to make the image look brighter. On the other hand, when the luminance level of a video signal is low (the image is dark), the iris is closed to make the image look darker.

However, the intensity distribution of the light (display light) passed through the spatial light modulation device to the screen will have different angle-dependent intensity distribution between when the variable iris is opened and when it is closed. The change in the angle-dependent intensity distribution of a display light causes luminance nonuniformity and color nonuniformity within a display region, thus deteriorating display image quality.

In view of the foregoing, for example, Japanese Unexamined Patent Application Publication No. 2004-111724 discloses the projection display apparatus configured to reduce luminance nonuniformity and the like due to the change in the angle-dependent intensity distribution of a display light, by dividing a display region into a plurality of ranges, and correcting video signals (performing uniformity correction) per divided region, depending on the amount of light intercepted by the variable iris.

### SUMMARY OF THE INVENTION

The abovementioned video signal correction according to the amount of light intercepted by the variable iris demands a plurality of types of correction data depending on the magnitude of the amount of light interception. In this case, a finer uniformity correction according to the amount of light interception increases the amount of correction data. As a result, the data amount may become extremely large, necessitating an extremely large storage area. This needs a large number of storage elements, thus raising manufacturing costs and the like.

This issue is not limited to the case of having the variable iris, but the same is true for the case of having other element for changing the angle-dependent intensity distribution of a display light. This issue is also not limited to the projection display apparatus, but the same is true for the direct-view type display such as liquid crystal display televisions.

Thus, when the angle-dependent intensity distribution of a display light is changed, it is difficult for the above related art to achieve, for example, both contrast ratio improvement and luminance nonuniformity reduction without raising manufacturing costs. There is a need for improvement.

It is desirable to provide a display apparatus capable of achieving, when the angle-dependent intensity distribution of a display light is changed, both contrast ratio improvement and luminance nonuniformity reduction without raising manufacturing costs.

According to an embodiment of the present invention, there is provided a display apparatus including a light source, a spatial light modulation device, intensity distribution adjusting means and correction means. The spatial light modulation device modulates light emitted by the light source based on a video signal. The intensity distribution adjusting means changes the angle-dependent intensity distribution of an incident light in response to luminance factor in the video signal. The intensity distribution adjusting means is arranged ahead of or behind the spatial light modulation device. The correction means corrects the video signal in accordance with an intensity distribution adjusted by the intensity distribution adjusting means, and supplies a corrected video signal to the spatial light modulation device. The correction means has a plurality of correction tables each corresponding to a predetermined intensity distribution, generates a mixed correction value by mixing correction values in the plurality of correction tables at a mixing ratio determined by an individual intensity distribution, and corrects the video signal by using the mixed correction value.

In the display apparatus of the embodiment of the present invention, the spatial light modulation device modulates the light emitted by the light source based on a video signal, so that the image is displayed based on the video signal. In response to the luminance factor in the video signal, the intensity distribution adjusting means adjusts the angle-dependent intensity distribution of the light entered into the spatial light modulation device or the light passed through the spatial light modulation device. This enables a contrast ratio and the like to be adjusted according to image brightness. Further, the video signal is corrected in accordance with the intensity distribution adjusted by the intensity distribution adjusting means, and the image is displayed by supplying the corrected video signal to the spatial light modulation device. Therefore, even when the angle-dependent intensity distribution of a display light is changed with the intensity distribution adjustment, it becomes possible to adjust the luminance distribution within a display region. The video signal is corrected by using a mixed correction value generated by mixing correction values in a plurality of correction tables each corresponding to a predetermined intensity distribution. Therefore, the number of correction tables may be minimized than the case where different correction tables are assigned to different intensity distribution, respectively.

The intensity distribution of the light entered into the spatial light modulation device or the light passed through the spatial light modulation device is adjusted in response to luminance factor in the video signal. This enables the contrast ratio and the like to be adjusted and improved according to image brightness. Further, the video signal is corrected in accordance with the intensity distribution adjusted by the intensity distribution adjusting means, and the image is displayed based on the corrected video signal. Therefore, even when the intensity distribution of a display light is changed, the luminance distribution within a display region may be adjusted to reduce luminance nonuniformity and the like. The video signal is also corrected by using a mixed correction value generated by mixing correction values in a plurality of correction tables. Therefore, the number of correction tables may be minimized to reduce manufacturing costs. Hence, when the intensity distribution of a display light is changed, both contrast ratio improvement and luminance nonuniformity reduction may be attained without raising manufacturing costs.

Other and further objects, features and advantages of the invention will appear more fully from the following description.

### BRIEF DESCRIPTION OF THE DRAWINGS

FIG. 1 is a block diagram showing the configuration of a display apparatus according to an embodiment of the present invention;

FIG. 2 is a characteristic diagram showing an example of luminance histogram distribution generated by a video signal processing unit;

FIGS. 3A and 3B are schematic diagrams showing examples of correction tables held by a uniformity correction unit, respectively;

FIG. 4 is a schematic diagram showing an example of lookup tables held by the uniformity correction unit; and

FIGS. 5A to 5C are schematic diagrams for explaining an example of correction processing performed by the uniformity correction unit.

### DETAILED DESCRIPTION OF THE PREFERRED EMBODIMENTS

A preferred embodiment of the present invention will now be described in detail with reference to the accompanying drawings.

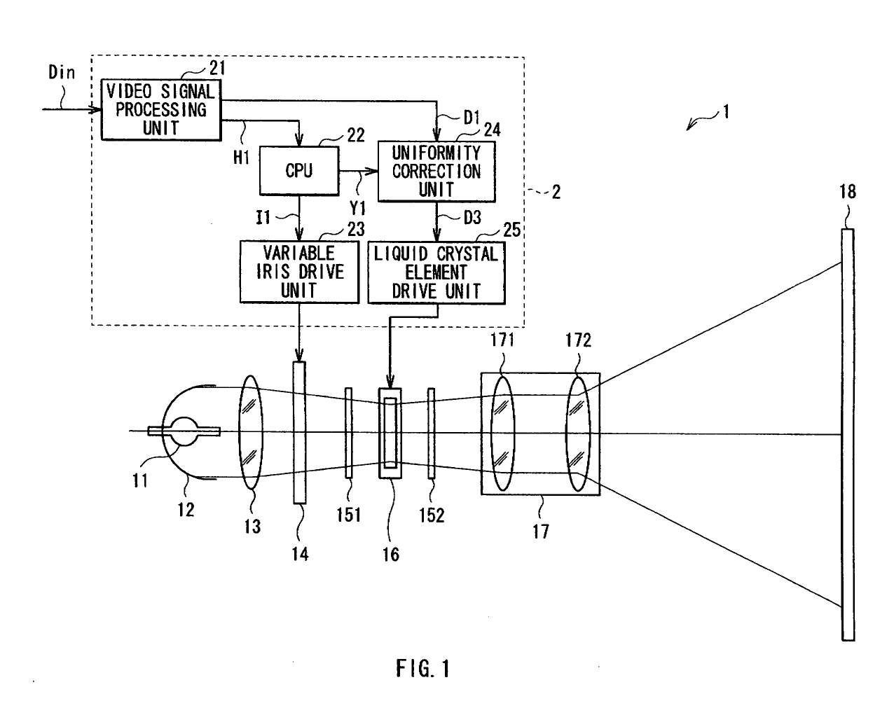

FIG. 1 shows the entire configuration of a display apparatus (a liquid crystal projector 1) according to an embodiment. The liquid crystal projector 1 is for displaying an image based on an input video signal Din supplied from the outside, and configured by a light source 11, a reflecting mirror 12, an illumination optical system 13, a variable iris 14, a polarizer 151, a liquid crystal element 16, an analyzer 152, a projection lens unit 17, a screen 18, and a controller 2 to control the variable iris 14 and the liquid crystal element 16 based on the input video signal Din.

The light source unit 11 emits white light containing red light (R), blue light (B) and green light (G) necessary for color image display, and is configured by, for example, a halogen lamp, a metal halide lamp or a xenon lamp.

The reflecting mirror 12 reflects the light emitted by the light source 11 toward the illumination optical system 13. The illumination optical system 13 is arranged between the light source 11 and the reflecting mirror 12, and the variable iris 14.

The polarizer 151 and the analyzer 152 have polarization axes orthogonal to each other, which function to split the entered color lights into two polarized components orthogonal to each other. Specifically, the polarizer 151 reflects one of these two polarized components (for example, an S-polarized component) and admits the other polarized component (for example, a P-polarized component). The analyzer 152 admits the former (the S-polarized component) and reflects the latter (the P-polarized component).

The liquid crystal element 16 modulates the light traveling from the light source 11 and passing through the illumination optical system 13 and the variable iris 14 described later, based on a video signal supplied from the controller 2 described later. The liquid crystal element 16 is arranged between the polarizer 151 and the analyzer 152. For example, the liquid crystal element 16 has a structure that a liquid crystal layer containing liquid crystal molecules is held between a pair of substrates to which a drive voltage based on a video signal is applied.

The variable iris 14 is arranged between the illumination optical system 13 and the polarizer 151, and is a mechanical shutter having an aperture (not shown) whose size is variable. Specifically, the aperture size is increased or decreased under the control of the controller 2 described later. Thus, the amount of light interception against the incident light is changed to change the angle-dependent intensity distribution of the incident light. The change in the angle-dependent intensity distribution of the incident light, as will be described later in detail, is adjusted in response to the luminance factor in an input video signal Din (for example, a luminance histogram distribution H1).

The projection lens unit 17 is arranged between the polarizer 152 and the screen 18, and configured by a pair of lenses 171 and 172. The light modulated by the liquid crystal element 16 is passed through the projection lens unit 17 and projected onto the screen 18.

The controller 2 has a video signal processing unit 21, a CPU (central processing unit) 22, a variable iris drive unit 23, a uniformity correction unit 24 and a liquid crystal element drive unit 25.

The video signal processing unit 21 has a function of generating a video signal D1 (pre-correction data D1) by subjecting an input video signal Din to white balance adjustment and so-called gamma correction for the purpose of adjusting the color temperature of a video signal. This permits adjustment for improving the image quality of a display image.

The video signal processing unit 21 also has a function of generating, based on the input video signal Din, a luminance histogram distribution H1 (the distribution of frequency values corresponding to luminance levels, respectively) in a display region, and supplying the luminance histogram distribution H1 to the CPU 22.

Based on the luminance histogram distribution H1 supplied from the video signal processing unit 21, the CPU 22 generates a value corresponding to representative data of the luminance of the display region (an iris setting value I1, e.g. the information of iris setting to, for example, 65000 stages), and supplies the iris setting value I1 to the variable iris drive unit 23. The CPU 22 also generates luminance factor Y1 depending on the magnitude of the iris setting value I1 (for example, a 9-stage luminance level information according to the magnitude of the iris setting value I1), and supplies the luminance factor Y1 to the uniformity correction unit 24. The details of the operation of the CPU 22 will be described later.

The variable iris drive unit 23 is configured by a motor for displacing the aperture of the variable iris 14, a motor driver for driving the motor, and the like. Based on the iris setting value I1 supplied from the CPU 22, the variable iris drive unit 23 controls the aperture size of the variable iris 14, particularly controls the amount of light interception of the light entered into the variable iris 14 (i.e. the angle-dependent intensity distribution of the incident light).

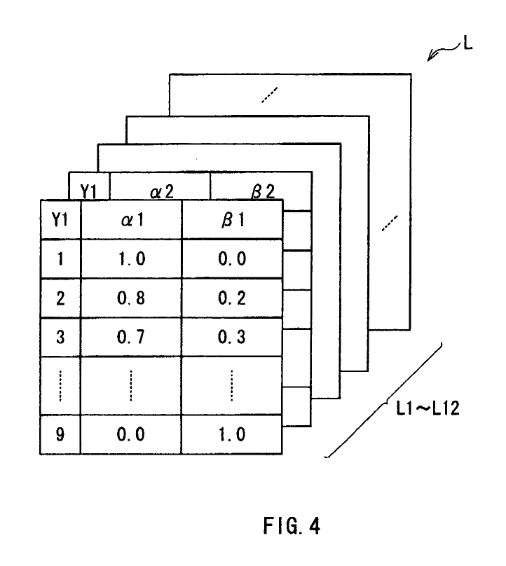

In accordance with the luminance factor Y1 supplied from the CPU 22, the uniformity correction unit 24 corrects the video signal based on the pre-correction data D1 supplied from the video signal processing unit 21, and supplies a corrected video signal D3 (corrected data D3) to the liquid crystal element drive unit 25. Specifically, the uniformity correction unit 24 has, for example, two correction tables corresponding to two values of luminance factor Y1 different from each other (two correction tables A and B corresponding to the minimum value and the maximum value of the luminance factor Y1, respectively), as shown in FIGS. 3A and 3B, and a lookup table (LUT) L associating the value of the luminance factor Y1 with the values of mixing ratios α and β described later of the two correction tables A and B, as shown in FIG. 4. These two correction tables A and B and the lookup table L are used to perform video signal correction (uniformity correction) in units of a plurality of pixel regions 3 determined by dividing a display region based on the video signal D1, as shown in FIGS. 3A and 3B. Further, these two correction tables A and B and the lookup table L are configured by a plurality sheets (e.g. 12 sets) of tables A1 to A12, B1 to B12 and L1 to L12, respectively, which correspond to the luminance level (e.g. a 12-stage luminance level) of the video signal D1 for each of the pixel regions 3. Similarly, the mixing ratios α and β in the lookup table L are changed with the luminance level (e.g. a 9-stage luminance level) of the luminance factor Y1.

A mix correction table, the details of which will be described later, is generated by mixing the abovementioned two correction tables A and B at the mixing ratios α and β (α+β=1) expressed by the following equation (1). In other words, mixed correction values (correction data D2) are generated by mixing the individual correction values in the correction tables A and B at the mixing ratios α and β, and the correction data D2 are added to the pre-correction data D1 (when the entire screen is formed with white data), thereby generating the corrected data D3 as shown in the following equation (2).

D2=α×A+β×B (1)

D3=D1+D2 (2)

The liquid crystal drive unit 25 drives the liquid crystal element 16, based on the corrected data D3 supplied from the uniformity correction unit 24.

In the present invention, the variable iris 14 corresponds to a specific example of “intensity distribution adjusting means,” the liquid crystal element 16 corresponds to a specific example of “spatial light modulation device,” the uniformity correction unit 24 corresponds to a specific example of “correction means,” “projection lens unit 17 corresponds to a specific example of “projection means,” the luminance histogram distribution H1 corresponds to a specific example of “luminance factor in a video signal,” and the iris setting value I1 corresponds to a specific example of “intensity distribution.”

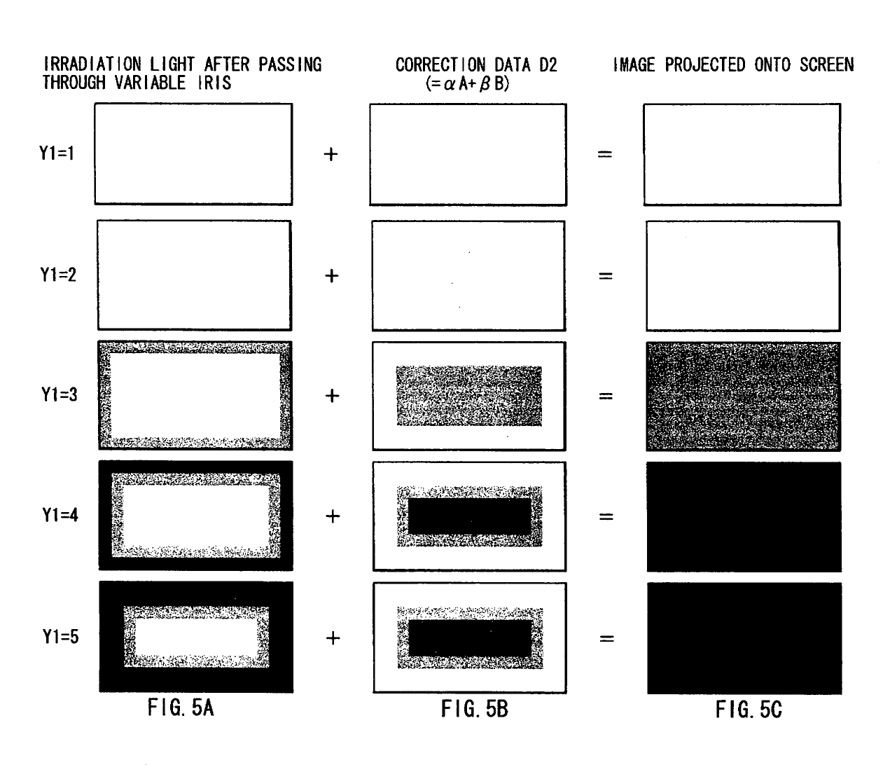

The operation of the liquid crystal projector 1 of the present embodiment will be described in detail with reference to FIGS. 1 to 5C. FIGS. 5A to 5C show schematically the correction processing performed by the uniformity correction unit 24 in accordance with the value of the luminance data Y1. That is, FIG. 5A shows the irradiation light from the light source 11 after passing through the variable iris 14; FIG. 5B shows the correction data D2; and FIG. 5C shows the image projected onto the screen 18. In FIGS. 5A to 5C, for the sake of convenience, the values of the luminance data Y1 are set to five stages “1” to “5”.

In the liquid crystal projector 1, as shown in FIG. 1, the light from the light source 11 is reflected by the reflecting mirror 12 and passed through the illumination optical system 13 and the variable iris 14. The polarizer 151 and the analyzer 152 separate polarized components of the light. The liquid crystal element 16 performs modulation based on the video signal D3 supplied from the liquid crystal element drive unit 25. The projection lens unit 17 projects the modulated light onto the screen 18, thereby displaying the image based on the input video signal Din.

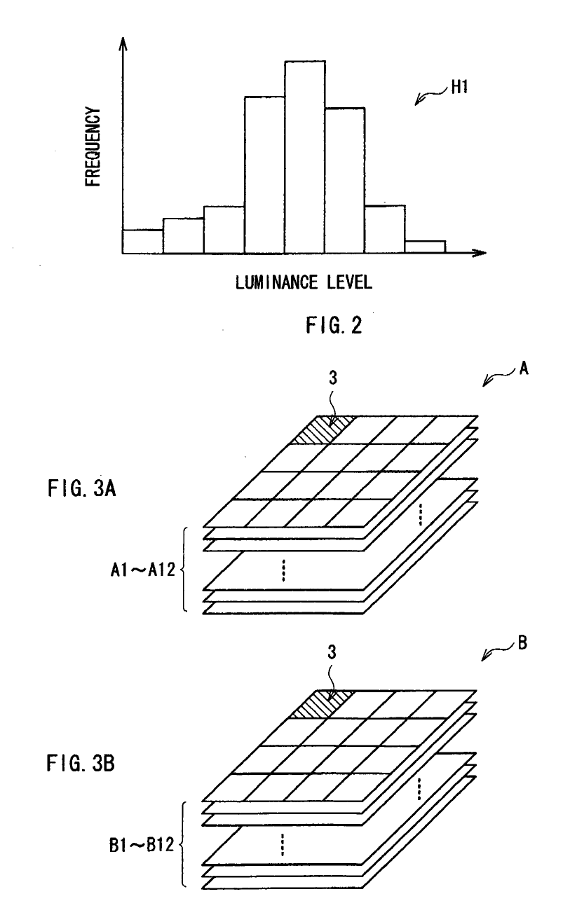

In the controller 2, the video signal processing unit 21 generates the video signal D1 by subjecting the input video signal Din to white balance adjustment and gamma correction, and generates the luminance histogram distribution H1 based on the input video signal Din, as shown in FIG. 2. Based on the luminance histogram distribution H1, the CPU 22 generates and supplies the iris setting value I1 and the luminance factor Y1 to the variable iris drive unit 23 and the uniformity correction unit 24, respectively. Depending on the magnitude of the iris setting value I1, the variable iris drive unit 23 adjusts the aperture size of the variable iris 14 (the amount of light interception of the light entered into the variable iris 14, that is, the angle-dependent intensity distribution of the incident light). Specifically, when the magnitude of the iris setting value I1 is large (the luminance level of the input video signal Din is high, that is, the image is bright), an adjustment is made to increase the aperture size (to open the aperture) of the variable iris 14, so that the amount of light intercepted by the variable iris 14 is decreased to improve display luminance. On the other hand, when the magnitude of the iris setting value I1 is small (the luminance level of the input video signal Din is low, that is, the image is dark), an adjustment is made to decrease the aperture size (to close the aperture) of the variable iris 14, so that the amount of light intercepted by the variable iris 14 is increased to suppress display luminance. Thus, the amount of light interception of the light entered into the liquid crystal element 16 (the angle-dependent intensity distribution of the incident light) is adjusted based on the luminance factor in the input video signal Din (the luminance histogram distribution H1). Hence, it becomes possible to adjust the contrast ratio and the like according to image brightness.

According to the luminance factor Y1 supplied from the CPU 22, the uniformity correction unit 24 corrects the video signal based on the video signal D1 (the pre-correction data D1), and supplies the corrected video signal D3 (the corrected data D3) to the liquid crystal element drive unit 25. Specifically, the corrected data D3 is generated by adding the generated correction data D2 to the pre-correction data D1, depending on the value of the luminance factor Y1, as shown in FIGS. 5A to 5C and the foregoing equations (1) and (2). Thus, the video signal D1 is corrected according to the luminance factor Y1 corresponding to the iris setting value I1, and the liquid crystal element 16 is driven to display the image based on the corrected video signal D3. Hence, for example, even when the angle-dependent intensity distribution of a display light (the irradiation light after passing through the variable iris 14) is changed with the luminance factor Y1 (when the display luminance within the display region is changed), as shown in FIG. 5A, the luminance distribution within the display region is able to be adjusted to provide, for example, the image projected onto the screen 18, as shown in FIG. 5C.

The uniformity correction unit 24 performs the abovementioned correction by using the two correction tables A and B as shown in FIGS. 3A and 3B, and the lookup table L as shown in FIG. 4. That is, the correction is performed by using the mixed correction values generated by mixing the individual correction values in the two correction tables A and B, corresponding to the two luminance factor Y1 different from each other (the amount of light interception of the light entered into the liquid crystal element 16, namely the intensity distribution). Therefore, the number of correction tables is minimized (two tables) than the related art in which different correction tables are assigned to different intensity distribution, respectively (e.g. 5-stage luminance factor Y1=1 to Y1=5 in the example of FIGS. 5A to 5C).

In the foregoing embodiment, the amount of light interception of the light entered into the liquid crystal element 16 (the intensity distribution) is adjusted based on the luminance factor (the luminance histogram distribution H1) in the input video signal Din. Therefore, the contrast ratio and the like are adjusted according to image brightness, enabling to improve the contrast ratio and the like. Further, the video signal D1 is corrected according to the amount of light interception of the light entered into the liquid crystal element 16 (the intensity distribution), and the image is displayed based on the corrected video signal D3. Therefore, even when the angle-dependent intensity distribution of a display light is changed (even when the luminance within the display region is changed), it is capable of adjusting the luminance distribution within the display region, permitting a reduction in luminance nonuniformity and the like within the display region. The video signal D1 is corrected by using the mixed correction values generated by mixing the individual correction values in the two correction tables A and B. This minimizes the number of correction tables, suppressing manufacturing costs. Hence, when the angle-dependent intensity distribution of a display light is changed, both contrast ratio improvement and luminance nonuniformity reduction is able to be achieved without raising manufacturing costs.

The two correction tables A and B and the lookup table L are configured by a plurality sheets (e.g. 12 sets) of tables A1 to A12, B1 to B12 and L1 to L12, respectively, which correspond to the luminance levels (e.g. a 12-stage luminance level) of the video signal D1 in units of the pixel regions 3. This enables a more adequate uniformity correction capable of further reducing luminance nonuniformity and the like, depending on the luminance level of the video signal D1 in units of the pixel regions 3.

Similarly, the mixing ratios α and β in the lookup table L are changed with the luminance level (e.g. a 9-stage or a 5-stage luminance level) of the luminance factor Y1. This enables a more adequate uniformity correction capable of further reducing luminance nonuniformity and the like, depending on the luminance level of the luminance factor Y1.

Further, the video signal D1 is corrected in units of the plurality of pixel regions 3 determined by dividing the display region based on the video signal D1. Therefore, the correction is able to be performed easily with less processing burden than the correction per unit display pixel.

The foregoing embodiment is directed to the case of employing the two types of correction tables A and B and the two types of mixing ratios α and β. Instead of these two types of correction tables and these two types of mixing ratios, any of a plurality of different types may be set. For example, as shown in the following expressions (3) and (4), corrected data D3A may be generated by generating pre-correction data D2A by using three types of correction tables A, B and C having different magnitudes of luminance factor Y1 and their respective corresponding mixing ratios α, β and γ (α+β+γ=1), and by adding the pre-correction data D2A thus generated to pre-correction data D1. The amount of change of the degree of luminance nonuniformity within a display region with respect to the luminance factor Y1 is usually not a linear change. Therefore, by using a plurality of types of correction tables and mixing ratios corresponding to the non-linear change, a still more adequate uniformity correction capable of further reducing luminance nonuniformity and the like may be performed than the foregoing embodiment.

D2A=α×A+β×B+γ×C (3)

D3A=D1+D2A (4)

Although the foregoing embodiment is directed to the case where the mixing ratios α and β are changed with the luminance level of the video signal D1, these two mixing ratios may be set as fixed values, irrespective of the luminance level of a video signal. The correction may be performed easily with less processing burden than the foregoing embodiment.

Although the foregoing embodiment is directed to the case where the correction tables A and B and the lookup table L are configured by 12 sets, respectively, and the mixing ratios α and β in the lookup table L are changed by 9-stage or 5-stage, these numbers are cited merely by way of example and any number may be set.

Although the foregoing embodiment is directed to the case where the video signal D1 is corrected in units of the plurality of pixel regions 3 determined by dividing the display region based on the video signal D1, the correction may be performed per unit display pixel, for example. This makes it possible to perform a more adequate uniformity correction capable of further reducing luminance nonuniformity and the like than the foregoing embodiment.

Although in the foregoing embodiment, the variable iris 14 is arranged ahead of the liquid crystal element 16, the variable iris 14 may be arranged behind the liquid crystal element 16 (e.g. between the analyzer 152 and the projection lens unit 17) so as to adjust the amount of light interception of the light passed through the liquid crystal element 16.

Although the foregoing embodiment employs the variable iris as an example of intensity distribution adjusting means, a zoom lens having, for example, an optical zoom function may be provided as other intensity distribution adjusting means.

Although the foregoing embodiment is directed to the case where the spatial light modulation device is the liquid crystal element (the liquid crystal element 16) and configured as the liquid crystal display (the liquid crystal projector 1), for example, a DMD (digital micromirror device) may be used as other spatial light modulation device.

Although the foregoing embodiment is directed to the case where the projection means (the projection lens unit 17) for projecting the light modulated by the spatial light modulation device (the liquid crystal element 16) onto the screen 18 is provided to configure as the projection display apparatus (the liquid crystal projector 1), the present invention is also applicable to a direct-view type display apparatus (e.g. a television apparatus).

While the present invention has been described by the foregoing embodiment and examples, without limiting to these, many changes and modifications may be made. It should be understood by those skilled in the art that various modifications, combinations, sub-combinations and alterations may occur depending on design requirements and other factors insofar as they are within the scope of the appended claims or the equivalents thereof.

What is claimed is:

1. A display apparatus comprising:
a light source;
spatial light modulation device for modulating light emitted by the light source based on a video signal;
intensity distribution adjusting means for changing an angle-dependent intensity distribution of an incident light in response to luminance factor in the video signal, the intensity distribution adjusting means being arranged ahead of or behind the spatial light modulation device; and
correction means for correcting the video signal in accordance with an intensity distribution adjusted by the intensity distribution adjusting means, and supplying a corrected video signal to the spatial light modulation device, wherein
the correction means has a plurality of correction tables each corresponding to a predetermined intensity distribution, generates a mixed correction value by mixing correction values in the plurality of correction tables at a mixing ratio determined by an individual intensity distribution, and corrects the video signal by using the mixed correction value.

2. The display apparatus according to claim 1, wherein each of the plurality of correction tables includes a plurality sheets of tables each corresponding to a luminance level of the video signal.

3. The display apparatus according to claim 2, wherein the mixing ratio is changed with the luminance level of the video signal.

4. The display apparatus according to claim 1, wherein the correction means performs correction by using a corresponding mixed correction value, for each of a plurality of pixel regions determined by dividing a whole display region.

5. The display apparatus according to claim 1, wherein the luminance factor in the video signal is based on a luminance histogram distribution in a whole display region.

6. The display apparatus according to claim 1, wherein the intensity distribution adjusting means is a variable iris to stop down an incident light.

7. The display apparatus according to claim 1, wherein the intensity distribution adjusting means is a zoom lens having an optical zoom function.

8. The display apparatus according to claim 1, wherein the spatial light modulation device is a liquid crystal element, the display apparatus being configured as a liquid crystal display.

9. The display apparatus according to claim 1, further comprising projection means for projecting light modulated by the spatial light modulation device onto a screen, the display apparatus being configured as a projection display apparatus.

10. A display apparatus comprising:
a light source;
spatial light modulation device for modulating light emitted by the light source based on a video signal;
intensity distribution adjusting section changing an angle-dependent intensity distribution of an incident light in response to luminance factor in the video signal, the intensity distribution adjusting section being arranged ahead of or behind the spatial light modulation device; and
correction section correcting the video signal in accordance with an intensity distribution adjusted by the intensity distribution adjusting section, and supplying a corrected video signal to the spatial light modulation device, wherein
the correction section has a plurality of correction tables each corresponding to a predetermined intensity distribution, generates a mixed correction value by mixing correction values in the plurality of correction tables at a mixing ratio determined by an individual intensity distribution, and corrects the video signal by using the mixed correction value.
